(19) United States
(12) Patent Application Publication
(10) Pub. No.: US 2012/0239654 A1
(43) Pub. Date: Sep. 20, 2012

(54) RELATED DOCUMENT SEARCH SYSTEM, DEVICE, METHOD AND PROGRAM

(75) Inventors: Kenji Tateishi, Tokyo (JP); Itaru Hosomi, Tokyo (JP); Dai Kusui, Tokyo (JP)

(73) Assignee: NEC CORPORATION, Tokyo (JP)

(21) Appl. No.: 13/513,398

(22) PCT Filed: Nov. 26, 2010
(86) PCT No.: PCT/JP2010/071618

§ 371 Date: Jun. 1, 2012

(30) Foreign Application Priority Data
Dec. 4, 2009 (JP) 2009-276852

(51) Int. Cl. G06F 17/30

(52) U.S. Cl. 707/737; 707/E17.091

(57) ABSTRACT

Provided is a related document search system which can provide supplementary information showing a related content together with a related document related to a predetermined document.

The related document search device according to the invention of the present application comprises procedure group creation means for extracting data of a portion corresponding to the procedure indicating operation or state from document data and creating a group of procedures to which all procedures that are required to be performed in order to solve a problem belong by using the data of the portion corresponding to the extracted procedure as information on a procedure group and supplementary information detection means for detecting the procedure group including a procedure that is the same as or similar to any procedure which belongs to the procedure group included in a predetermined document data and a procedure that is not the same as or not similar to any procedure which belongs to the procedure group included in the predetermined document data from related document data by using the created information on the procedure group as the procedure group including supplementary information which supplements the content of the predetermined document data.

### TECHNICAL FIELD

The present invention relates to a related document search system that search for related document data related to a predetermined document data, a related document search device, a related document search method, and a related document search program.

### BACKGROUND ART

An operator of a customer service desk of a company refers to a past-inquiry log document and answers the customer's inquiry. Generally, the past-inquiry log document includes a question part and an answer part. A content of a question about a problem asked by a customer is described in the question part. A countermeasure to the problem that is answered by the operator is described in the answer part. The operator searches for the past-inquiry log document whose content described in the question part thereof is the same as the content of the question currently asked and answers the question by referring to the content of the answer part in order to present a countermeasure.

At this time, necessary and sufficient information is not necessarily described in one of the inquiry log documents. Therefore, in fact, the operator has to collect information by reading a plurality of inquiry log documents. However, because time is limited, when the operator finds a first desirable inquiry log document, the operator tends to answer the question without referring to the other inquiry log documents. In other words, there is a problem in which insufficient information is collected when answering the question.

As a method for solving this problem, a method in which a related document is presented together with the inquiry log document that is an object to be read selected by the operator is used. Specifically, another inquiry log document of which content of the question part is the same as or similar to that of the inquiry log document that is the object to be read is presented as the related document. Because the operator can read the related document together with the inquiry log document that is the object to be read, the insufficient information collection can be avoided. For example, a technology described in non-patent document 1 is a related document search system for a Web page but it can be applied for the past-inquiry log document.

As a related technology, the patent document 1 discloses a system for collecting information required for trouble analysis when troubleshooting for a software tool is performed.

As a related technology, the patent document 2 discloses a question answering device by which when an answer to a question is presented, the answer in which information included in a basis document is taken into consideration can be presented.

As a related technology, the patent document 3 discloses a question and answer search system which searches for a sentence of an answer to a sample case to a question with a high degree of accuracy.

### PRIOR ART DOCUMENT

### Patent Document

[Patent document 1] Japanese Patent Application Laid-Open No. 1996-087423

[Patent document 2] Japanese Patent Application Laid-Open No. 2005-025418

[Patent document 3] Japanese Patent Application Laid-Open No. 2006-244262

### Non-Patent Document

[non-Patent document 1] Keigo Nakatani, Yu Suzuki, Kyoji Kawagoe, “Personalized Web Link Generation Method using Keywords and Document Similarities”, The Database Society of Japan Letters Vol. 4, No. 1, pp. 89 to 92, 2005.

### BRIEF SUMMARY OF THE INVENTION

### Problems to be Solved by the Invention

However, the system described in non-patent document 1, patent document 2, and patent document 3 merely represents information related to the answer to the input sentence such as the related document or the like. Therefore, the operator cannot understand which part of the inquiry log document that is the object to be read is supplemented by which part of the related document. By this problem, it takes much time for the operator to grasp the content of the related document. Additionally, by the same problem, the operator cannot get a positive motivation for reading the related document. Further, by the same problem, when a portion related to the input document is a part of the whole document, the operator has to read all the descriptions of the related document to recognize the relevant part. Therefore, this leads to wasteful information collection.

The system described in patent document 1 stores a plurality of related items (an error message, a tool name, an operation procedure, and the like) for each trouble and merely searches for the trouble information based on the item. Therefore, when the information is stored as document data, the system described in patent document 1 cannot be applied. Further, even if the related trouble information (related document) can be presented, the system described in patent document 1 cannot show that the designated information (the inquiry log document that is the object to be read) is supplemented by which part of the trouble information (related document) and how it is supplemented. Accordingly, the operator has to read all the descriptions of the trouble information (related document) and recognize the relevant part.

Accordingly, an object of the present invention is to provide a related document search system which can provide supplementary information showing a related content together with the related document related to a predetermined document, a related document search device, a related document search method, and a related document search program.

### Means for Solving the Problems

A related document search device according to the present invention includes procedure group creation means for extracting data of a portion corresponding to a procedure indicating operation or state from document data and creating a group of procedures to which all procedures that are required to be performed in order to solve a problem belong by using the data of the portion corresponding to the extracted procedure as information on the procedure group and supplementary information detection means for detecting the procedure group including a procedure that is the same as or similar to any procedure which belongs to the procedure group included in a predetermined document data and a procedure that is not the same as or not similar to any procedure which belongs to the procedure group included in the predetermined document data from the related document data by using the information on the procedure group created by the procedure group creation means as the procedure group including supplementary information which supplements the content of the predetermined document data.

A related document search method according to the present invention includes the steps of: extracting data of a portion corresponding to a procedure indicating operation or state from document data, creating a group of procedures to which all procedures that are required to be performed in order to solve a problem belong by using the data of the portion corresponding to the extracted procedure as information on the procedure group, and detecting the procedure group including a procedure that is the same as or similar to any procedure which belongs to the procedure group included in a predetermined document data and a procedure that is not the same as or not similar to any procedure which belongs to the procedure group included in the predetermined document data from the related document data by using the information on the procedure group that is created as the procedure group including supplementary information which supplements the content of the predetermined document data.

A related document search program according to the present invention which is stored in a program recording medium causes a computer to perform a procedure group creation process in which data of a portion corresponding to a procedure indicating operation or state is extracted from document data and a group of procedures to which all procedures that are required to be performed in order to solve a problem belong is created by using the data of the portion corresponding to the extracted procedure as information on the procedure group and a supplementary information detection process in which the procedure group including a procedure that is the same as or similar to any procedure which belongs to the procedure group included in a predetermined document data and a procedure that is not the same as or not similar to any procedure which belongs to the procedure group included in the predetermined document data is detected from the related document data by using the information on the procedure group that is created as the procedure group including supplementary information which supplements the content of the predetermined document data.

### Effect of the Invention

By using the present invention, the supplementary information showing the related content can be provided together with the related document related to the predetermined document.

### BRIEF DESCRIPTION OF THE DRAWINGS

FIG. 1 is an explanatory drawing showing an example of document data.

FIG. 2 is an explanatory drawing showing an example of display of related document data.

FIG. 3 is an explanatory drawing showing an example of document data.

FIG. 4 is an explanatory drawing showing an example of display of related document data.

FIG. 5 is a functional block diagram showing an example of a functional configuration of a related document search system according to a first exemplary embodiment.

FIG. 6 is a flowchart showing an example of a process performed by a related document search system in a first exemplary embodiment.

FIG. 7 is an explanatory drawing showing an example of document data stored by a document storage unit 20 in a first exemplary embodiment.

FIG. 8 is an explanatory drawing showing an example of storage of a procedure group storage unit 21 in a first exemplary embodiment.

FIG. 9 is a functional block diagram showing an example of a functional configuration of a related document search system according to a second exemplary embodiment.

FIG. 10 is a flowchart showing an example of a process performed by a related document search system in a second exemplary embodiment.

FIG. 11 is an explanatory drawing showing an example of document data stored by a document storage unit 20 in a second exemplary embodiment.

FIG. 12 is an explanatory drawing showing an example of storage of a procedure group storage unit 21 in a second exemplary embodiment.

FIG. 13 is a block diagram of a related document search device which shows an example of a related document search system with a minimum configuration.

FIG. 14 is a hardware configuration diagram of a related document search device.

### MODE FOR CARRYING OUT THE INVENTION

### Exemplary Embodiment 1

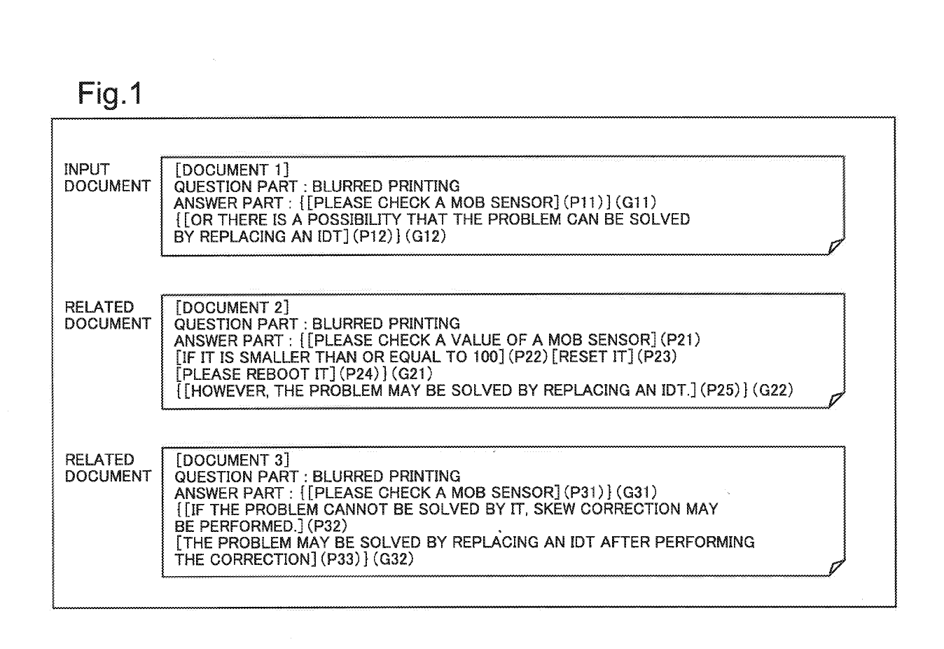

Hereinafter, a summary of a first exemplary embodiment of the present invention will be described. FIG. 1 is an explanatory drawing showing an example of document data. In this exemplary embodiment, a case in which when document data 1 shown in FIG. 1 is the object to be read by an operator, document data 2 and document data 3 are presented as the related document data will be explained as an example. The document data 2 and the document data 3 are the related document data of the document data 1. This is because the contents of the question parts of these data are similar to each other.

First, a procedure group creation unit (it corresponds to a procedure group creation unit 10 mentioned later) extracts data of a portion corresponding to a procedure (hereinafter, the data of the portion corresponding to the procedure is referred to as “a procedure”) from the answer part of the document data. The procedure represents one operation that has to be performed in order to solve a problem. The procedure is categorized into two: an explicit procedure and an implicit procedure. The explicit procedure represents a procedure of which the operation that has to be performed is described in the answer sentence directly. For example, the sentence that says “please check a MOB sensor” of the document data 1 shown in FIG. 1 corresponds to the explicit procedure. The implicit procedure represents a procedure by which an operation that has to be performed can be indirectly derived from a description of a state described in the answer sentence. The operation that has to be performed, for example, the operation “to confirm whether or not it is smaller than or equal to 100” can be derived from the sentence that says “If it is smaller than or equal to 100” of the document data 2 shown in FIG. 1. Therefore, this procedure corresponds to the implicit procedure. The procedure group creation unit recognizes one operation or state from one clause. It is understood that the content of the answer part is composed of a series of procedures. Therefore, the procedure group creation unit splits the answer part into clauses and whereby, it can extract the procedure from the answer part. In an example shown in FIG. 1, letters in square brackets “[]” represent one procedure.

Next, the procedure group creation unit creates a group of procedures (procedure group) to which all procedures that are required to be performed belong in order to solve a problem. Specifically, the procedure group creation unit 10 creates information which shows the procedure group. For example, in the document data 2, the procedures P21, P22, P23, and P24 belong to the same procedure group. That is because these all procedures have to be performed in order to solve the problem. On the other hand, a procedure P25 is not included in this procedure group. The reason for this is that there is a possibility that the problem can be solved by performing the procedures P21, P22, P23, and P24 even when the procedure P25 is not performed. Therefore, the procedure P25 belongs to another procedure group. In an example shown in FIG. 1, letters in brackets “{}” represent one procedure group. The procedure group creation unit associates the procedure group with the document data and makes a procedure group storage unit (it corresponds to a procedure group storage unit 21 mentioned later) store them.

The procedure group creation unit creates the procedure group by using for example, a connective expression between two adjacent procedures. Specifically, when the connective expression showing that if one procedure is performed, the problem is solved even when the other procedure is not performed (it is not necessary to perform both procedures in order to solve the problem) exists between two procedures, the procedure group creation unit puts the procedure after the connective expression in another procedure group. In this case, the related document search system has to choose the connection expression from a wider range than the connective expression showing a switch of subject (topic) (for example, “however”) as the expression showing that the consecutive procedures belong to the different procedure groups from each other. For example, the sentence that says “if the problem cannot be solved by it” shows that there is an association between two adjacent procedures. Therefore, this sentence is not the connective expression showing a switch of subject. However, this connective expression means that it is not necessary to perform the latter procedure if the problem is solved by performing the former (latter) procedure. Accordingly, the related document search system adopts this connective expression as the expression showing that the former procedure and the latter procedure belong to the different procedure groups from each other. Similarly, the related document search system adopts a word of “or” as the expression showing that the former procedure and the latter procedure belong to the different procedure groups from each other.

The related document search system performs the above-mentioned process in a back-end in advance. The related document search system displays the related document data by using the created procedure group in a front-end as follows.

First, a related document search unit (it corresponds to a related document search unit 12 mentioned later) searches for the related document data to the document data (input document data) that is the object to be read. In this example, the related document search unit searches for the document data whose content of the question part is similar to that of the document data 1 that is the input document data from the storage unit and extracts the document data 2 and the document data 3 as a search result. Additionally, the procedure group search unit searches for the procedure group included in the input document data or the related document data from the storage unit and extracts it.

Next, the supplementary information detection unit (it corresponds to a supplementary information detection unit 14 mentioned later) detects the procedure group (the procedure group including the supplementary information) including a procedure that is the same as or similar to any procedure of the procedure group of the input document data and a procedure that is not the same as or not similar to any procedure of the procedure group of the input document data from the related document data. In this example, a procedure P11 included in G11 of the input document data is similar to the procedure P21 of G21 included in the document data 2 and not similar to the procedure P22, P23, or P24 of G21. Therefore, the above-mentioned condition is satisfied. The supplementary information detection unit recognizes G21 as the procedure group including the supplementary information to G11 and detects it. Similarly, the supplementary information detection unit recognizes G12 as the procedure group including the supplementary information to G32 and detects it.

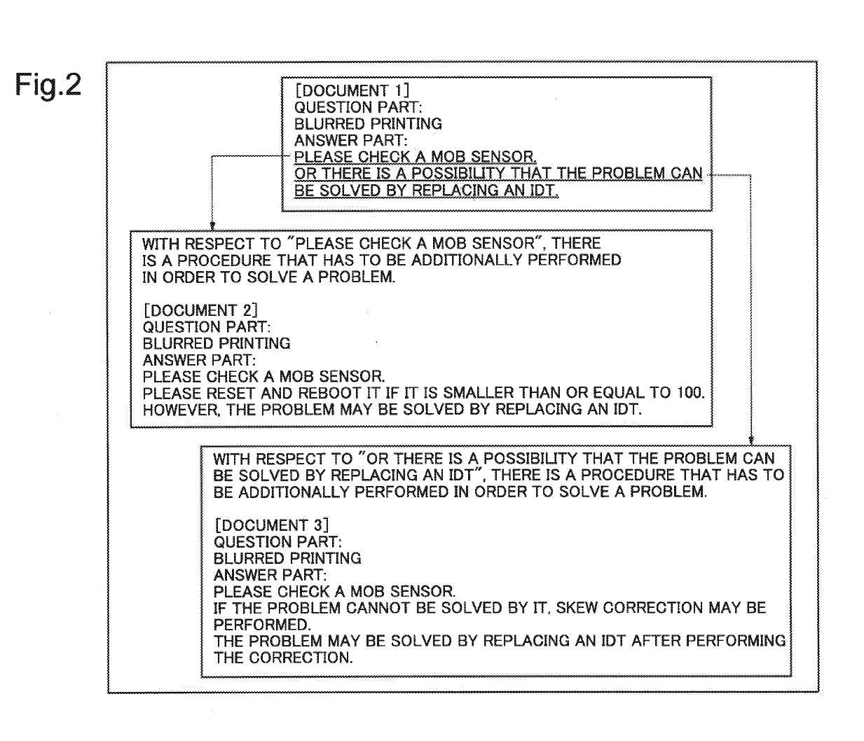

Finally, a supplementary information display control unit (it corresponds to a supplementary information display control unit 15 mentioned later) performs control so that the input document data and the related document data are associated with each other by using the procedure group including the supplementary information and these data are displayed in a display unit. For example, as shown in FIG. 2, the supplementary information display control unit writes an anchor text to a portion of G11. When the operator clicks the anchor text, the supplementary information display control unit performs control so that another window in which a sentence that says “there is a procedure that has to be additionally performed in order to solve the problem” and the content of G21 in the document data 2 are highlighted and displayed is displayed. Namely, the supplementary information display control unit performs control so that the another window in which the supplementary information indicating that another procedure required to solve the problem in performing the procedure group of the input document data is described in the procedure group of the related document data is described is displayed. By this operation, the operator can read the related document data after grasping the above-mentioned supplementary information. Therefore, the operator can easily grasp the content of the related document data. Further, the operator can grasp the supplementary information before reading the related document data and whereby, the operator can get the positive motivation for reading the content of the related document data.

Furthermore, the supplementary information display control unit writes the anchor text to the portion of G12. The supplementary information display control unit performs control so that the sentence that is the same as G12 and the content of G32 in the document data 3 is highlighted and displayed in a destination page linked by the anchor text. By this operation, it is enough for the operator to read only the portion of G21 of the document data 2 and the portion of G32 of the document data 3 in the related document data that are associated with the input document data. Therefore, information can be efficiently collected. In fact, the content of G22 of the document data 2 and the content of G31 of the document data 3 are the same as the content of the document data 1. Therefore, it is not necessary to redundantly read those contents.

Thus, in this exemplary embodiment, the procedure group creation unit, the supplementary information detection unit, and the supplementary information display control unit are included. The procedure group creation unit extracts the portion indicating the procedure from the document data and creates the group of the procedures (procedure group) to which all procedures that are required to be performed in order to solve a problem belong. The supplementary information detection unit detects the procedure group (the procedure group including the supplementary information) including a procedure that is the same as or similar to any procedure of the procedure group of the input document data and a procedure that is not the same as or not similar to any procedure of the procedure group of the input document data from the related document data. The supplementary information display control unit performs control so that the input document and the related document are associated with each other by using the procedure group including the supplementary information and displayed in the display unit.

Accordingly, this exemplary embodiment has the following effect. The related document search system notifies the operator of that the procedure group of the related document data to the procedure group of the input document data (the inquiry log document data that is the object to be read by the operator) is the procedure group including the specific supplementary information. By the notification, the operator can know in advance that another procedure required to solve the problem in performing the procedure group of the input document data is described in the procedure group of the related document data as the supplementary information.

Therefore, the operator can easily grasp the content of the related document. Further, the operator grasps the supplementary information in advance and whereby, the operator can get the positive motivation for reading the related document. Because it is enough for the operator to read only the portion of the associated procedure group in the related document data, the operator can efficiently collect information.

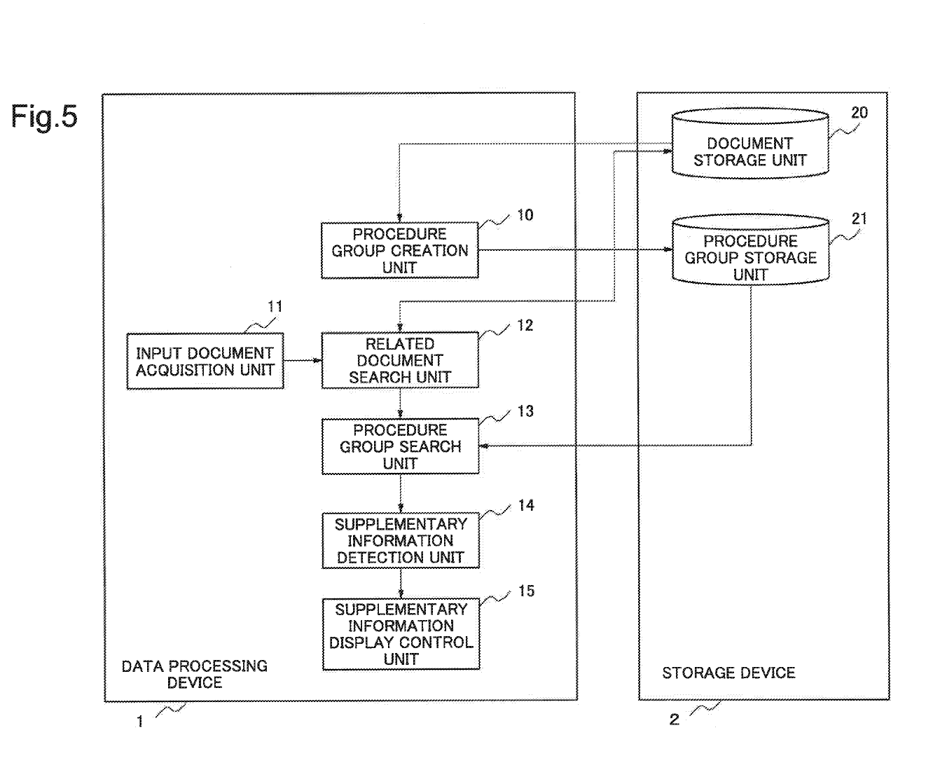

Next, an example of the configuration of the first exemplary embodiment of the present invention will be described with reference to the drawing. FIG. 5 is a functional block diagram showing an example of the functional configuration of the related document search system according to the first exemplary embodiment. By referring to FIG. 5, the related document search system according to the present invention includes a data processing device 1 which operates by program control and a storage device 2 for storing information. Specifically, the data processing device 1 is realized by an information processing device such as a personal computer or the like which operates according to program. Specifically, the storage device 2 is realized by a storage device such as a magnetic disk device, an optical disk device, or the like. In this exemplary embodiment, the related document search system includes the data processing device 1 and the storage device 2 that are realized as a stand-alone device. However, the configuration of these devices is not limited this. For example, the related document search system may be realized by using one information processing device that includes the storage unit therein. The related document search system may include a plurality of data processing devices 1.

The data processing device 1 includes the procedure group creation unit 10, an input document acquisition unit 11, a related document search unit 12, a procedure group search unit 13, a supplementary information detection unit 14, and a supplementary information display control unit 15.

Specifically, the procedure group creation unit 10 is realized by a CPU of the information processing device which operates according to program. The procedure group creation unit 10 has a function to extract the portion indicating the procedure from the document data and create the group of the procedures (procedure group) to which all procedures that are required to be performed in order to solve a problem belong. Specifically, the procedure group creation unit 10 creates information indicating the procedure group. The procedure group is a series of procedures that are performed in order to solve the problem by the predetermined method. Therefore, in order to solve the problem, it is necessary to perform all the procedures included in the procedure group.

Specifically, the input document acquisition unit 11 is realized by the CPU of the information processing device that operates according to program. The input document acquisition unit 11 has a function to acquire the document data (the input document data) that is the object to be read by the user (operator). For example, the input document acquisition unit 11 extracts the predetermined document data from a document storage unit 20 according to the user's (operator's) input operation.

Specifically, the related document search unit 12 is realized by the CPU of the information processing device that operates according to program. The related document search unit 12 has a function to search for the document data (the related document data) related to the input document data from the document storage unit 20. For example, the related document search unit 12 extracts the document data whose content of the question part is the same as or similar to that of the input document data from the document storage unit 20 as the related document data.

Specifically, the procedure group search unit 13 is realized by the CPU of the information processing device that operates according to program. The procedure group search unit 13 has a function to search for the procedure group associated with the input document data or the related document data from the procedure group storage unit 21.

Specifically, the supplementary information detection unit 14 is realized by the CPU of the information processing device that operates according to program. The supplementary information detection unit 14 has a function to detect the procedure group (the procedure group including the supplementary information) including a procedure that is the same as or similar to any procedure of the procedure group of the input document data and a procedure that is not the same as or not similar to any procedure of the procedure group of the input document data from the related document data.

Specifically, the supplementary information display control unit 15 is realized by the CPU of the information processing device that operates according to program. The supplementary information display control unit 15 has a function to perform control so that the input document and the related document are associated with each other by using the procedure group including the supplementary information and these documents are displayed in the display unit.

The storage device 2 includes the document storage unit 20 and a procedure group storage unit 21. The document storage unit 20 stores a set of the document data. The procedure group storage unit 21 associates the procedure group with the document data and stores them.

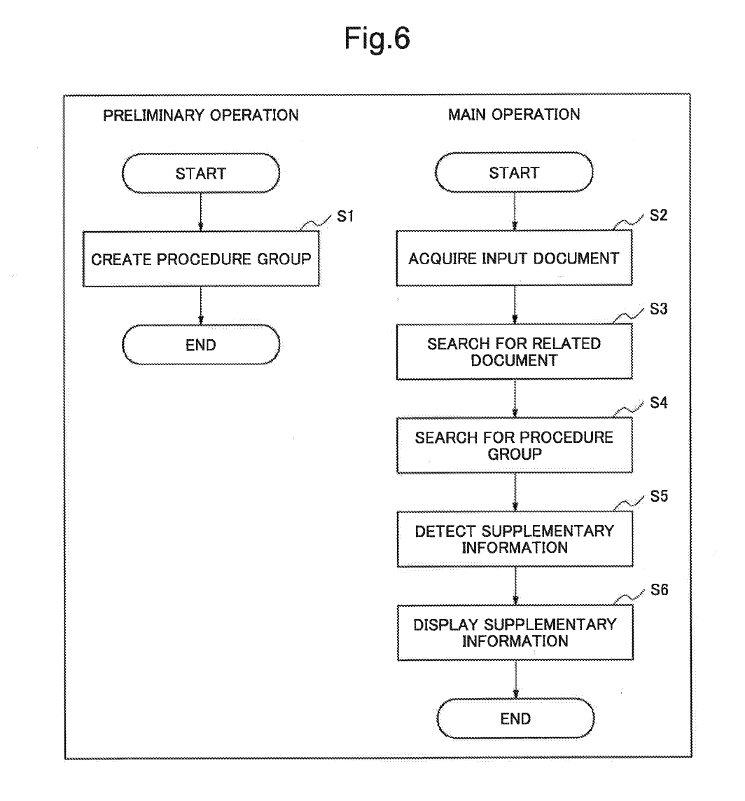

Next, the operation of the related document search system of the first exemplary embodiment will be described with reference to FIG. 6. FIG. 6 is a flowchart showing an example of a process performed by the related document search system in the first exemplary embodiment.

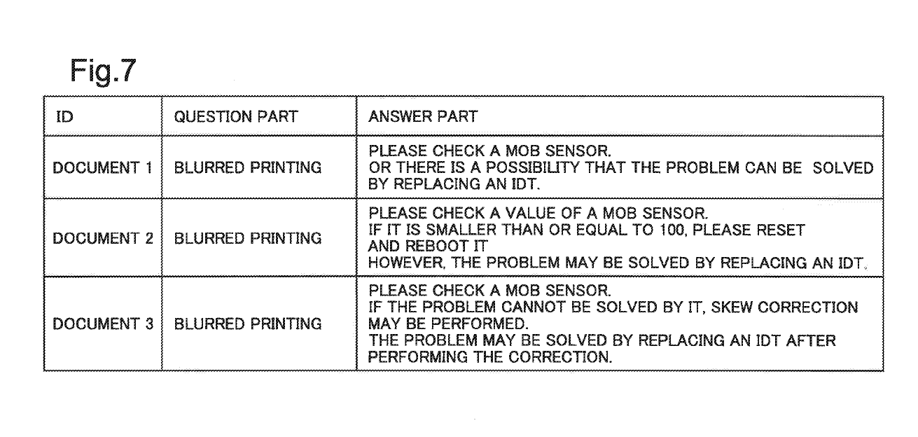

In the exemplary embodiment, it is assumed that the document storage unit 20 stores the document data 1, the document data 2, and the document data 3 as the set of the document data (the inquiry log document data) including the inquiry log information as shown in FIG. 7. FIG. 7 is an explanatory drawing showing an example of document data stored by the document storage unit 20.

In this exemplary embodiment, a case in which the user (operator) performs the input operation by which the document data 1 is designated as the document that is the object to be read and the input document acquisition unit 11 extracts the document data 1 from the document storage unit 20 according to the user's (operator's) operation will be explained as an example.

Further, in this exemplary embodiment, for example, the document data in which the question part (inquiry part) and the answer part are included like the inquiry log document data used in a general contact center and a series of procedures that shows a method for solving the problem is described in the answer part is used.

As a preliminary operation, the related document search system of the exemplary embodiment performs a process for creating the procedure group included in the document data stored by the document storage unit 20. For example, this preliminary operation is performed according to operation by a system administrator or the like or automatically performed for each predetermined period before the operator treats. After performing the preliminary operation, a process for acquiring the supplementary information to the related document by using the created procedure group is performed as a main operation.

The preliminary operation which is performed by the related document search system before the main operation will be described. First, as the preliminary operation, the procedure group creation unit 10 extracts the portion indicating the procedure from the document data stored by the document storage unit 20 and creates the group of the procedures (procedure group) to which all procedures that are required to be performed in order to solve a problem belong (step Si of FIG. 6). Specifically, the procedure group creation unit 10 creates information indicating the procedure group.

The procedure indicates one operation. The procedure is categorized into two: an explicit procedure and an implicit procedure. The explicit procedure represents a procedure of which the operation that has to be performed is described in the answer sentence directly. For example, the sentence that says “please check a MOB sensor” of the document 1 shown in FIG. 7 corresponds to the explicit procedure. The implicit procedure represents a procedure by which an operation that has to be performed can be indirectly derived from a description of a state described in the answer sentence. The operation that has to be performed, for example, the operation “to confirm whether or not it is smaller than or equal to 100” can be derived from the sentence that says “If it is smaller than or equal to 100” of the document data 2 shown in FIG. 7. Therefore, this procedure corresponds to the implicit procedure.

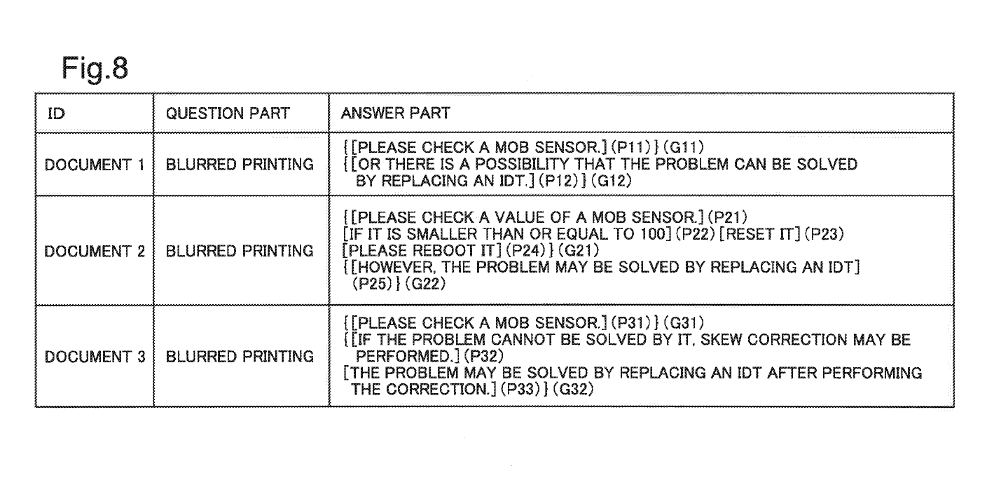

The procedure group creation unit 10 recognizes one operation or state from one clause. In this exemplary embodiment, the content of the answer part of the document data is composed of a series of procedures. Therefore, the procedure group creation unit 10 may extract the procedure from the document data by splitting the sentence of the answer part of the document into clauses. In FIG. 8, the result in which the procedure is extracted from the document data of the document storage unit 20 is shown.

In an example shown in FIG. 8, letters in square brackets “[]” represent one procedure.

Next, when the procedure group creation unit 10 creates the group of procedures (the procedure group) to which all procedures that are required to be performed in order to solve a problem belong, and makes the procedure group storage unit 21 stores the created procedure group.

For example, in the document data 2 shown in FIG. 7, the procedure group creation unit 10 determines that the procedures P21, P22, P23, and P24 belong to the same procedure group and creates the procedure group. That is because these all procedures have to be performed in order to solve the problem. On the other hand, the procedure P25 is not included in this procedure group. That is because there is a possibility that the problem can be solved by performing the procedures P21, P22, P23, and P24 even when the procedure P25 is not performed according to the description of the answer part of the document data 2. Therefore, the procedure group creation unit 10 determines that the procedure P25 belongs to another procedure group and creates another procedure group. Specifically, the procedure group creation unit 10 creates information indicating the procedure group. The procedure group creation unit 10 associates the procedure group with the document data and makes the procedure group storage unit 21 store them. FIG. 8 shows an example of storage. In an example shown in FIG. 8, letters in brackets “[]” represent one procedure group.

The related document search system may use a method for creating the procedure group in which a connective expression that connects two adjacent procedures with each other is used as one of the methods for creating the procedure group. Specifically, when the connective expression showing that if one procedure is performed, the problem is solved even when the other procedure is not performed (it is not necessary to perform both procedures in order to solve the problem) exists between two procedures, the procedure group creation unit 10 determines that the procedure after the connective expression belongs to another procedure group. When the above-mentioned connective expression does not exist, the procedure group creation unit 10 determines that two procedures belong to the same procedure group. In this case, the connection expression has to be chosen from a wider range than the connective expression showing a switch of the subject (topic) (for example, “However”) as the expression showing that the consecutive procedures belong to the different procedure groups from each other. For example, the statement that says “if the problem cannot be solved by it” shows that there is an association between two adjacent procedures. Therefore, this statement is not the connective expression showing a switch of subject. However, this connective expression means that it is not necessary to perform the latter (former) procedure if the problem is solved by performing the former (latter) procedure. Accordingly, the related document search system adopts the statement that says “if the problem cannot be solved by it” as the expression showing that the former procedure and the latter procedure belong to the different procedure groups from each other. Similarly, the related document search system adopts a word of “or” as the expression showing that the former procedure and the latter procedure belong to the different procedure groups from each other.

Further, the related document search system may use the following method as one of the methods for creating the procedure group. Namely, when the connective expression showing that it is necessary to perform two procedures in order to solve the problem exists between two adjacent procedures, the related document search system determines that two procedures belong to the same procedure group. When the connective expression showing that it is necessary to perform two procedures in order to solve the problem does not exist between two adjacent procedures, the related document search system determines that two procedures belong to the different procedure groups from each other. Thus, as the connective expression showing that it is necessary to perform both procedures, for example, a word of “if” or a sentence that says “if it exists” is used.

Further, the related document search system may use a method using a binary classifier as another method for creating the procedure group. The binary classifier automatically classifies data into two categories. Software on which the binary classifier is mounted can be easily obtained through the Web. When the software is used for the classification of the document data, the user (operator) prepares the following two items in advance. These items are (1) a word vector of the document data which is classified into two categories in advance and (2) a word vector of the document data which is not classified.

The word vector of the document data is a vector in which the word is used as a dimension and the presence or absence (0/1) of the word in the document data or an important degree of the word is stored as the value of each dimension. Software performs two processes: a learning process and a classification process. The software inputs the word vector of the document data that has been classified in advance and outputs the classifier in the learning process. The classifier usually stores classification reference data representing that what kind of a word included in the document data makes a possibility that the document data belongs to one of two categories high. Next, in the classification process, the software classifies the document data that has not been classified into the categories by using the classifier created in the learning process. Here, the expression saying that the software performs the process is used. However, specifically, the CPU of the information processing device performs the process. Further, the expression saying that the classifier stores data is used. However, specifically, the storage unit of the information processing device stores it.

In order to apply the software of this binary classifier to this exemplary embodiment, the document data that are the objects to be classified are set as two adjacent procedures and two categories that say “in order to solve the problem, whether both procedures have to be performed or not?” are set. In other words, when (1) the word vector of two adjacent procedures which have been classified into two categories in advance and (2) the word vector of two adjacent procedures which have not been classified are prepared, the content of the process is the same as that mentioned above. In this exemplary embodiment, when the procedure is classified as the category that says “in order to solve the problem, it is not necessary to perform two procedures” based on the classifier, the latter procedure of two adjacent procedures and a subsequent procedure can be set to another procedure group.

As an example of the software of the binary classifier that is currently available, SVM-Light (http://svmlight.joachims.org/) on which Support Vector Machine (SVM) is mounted as the binary classifier is shown. Further, C4.5 (http://www.rulequest.com/Personal/) on which the decision tree is mounted is available.

In an example mentioned above, the procedure group creation unit 10 performs the classification of two adjacent procedures as a target by using the binary classifier. However, it may perform the classification of all different two procedures included in the answer part as a target in which the procedures are adjacent each other. In this case, the procedure group creation unit 10 consolidates two procedures that are classified into the category that says “in order to solve the problem, it is necessary to perform two procedures” and creates the procedure group. For example, when five kinds of procedures A, B, C, D, and E exist in the answer part and {A, B}, {B, E}, and {C, D} are obtained by the classification, the procedure group creation unit 10 generates two procedure groups {A, B, E} and {C, D}.

The preliminary operation performed by the related document search system before performing the main operation has been explained above. The main operation performed by the related document search system will be described below.

When the inquiry from the customer is received in a contact center or the like, the user (operator) performs an operation to acquire the document data that is the object to be read by using the data processing device 1 in order to refer to the inquiry log document data. The input document acquisition unit 11 acquires the document data (input document data) that is the object to be read according to the user's (operator's) operation (step S2 of FIG. 6). For example, the input document acquisition unit 11 acquires the input document data itself or a document number by which the input document data can be specified. When the document number is acquired, the input document acquisition unit 11 refers to the document storage unit 20 and acquires the content of the document data. Namely, the input document acquisition unit 11 extracts the document data specified by the document number acquired from the document storage unit 20. With respect to the acquisition method, a method in which the document data that is directly inputted by the user (operator) by using the input terminal device is acquired is the simplest one but in a practical way, it is supposed that the document data displayed by another application is acquired. For example, the input document acquisition unit 11 acquires the inquiry log document data that is the search result which is obtained by the search system according to the user's (operator's) operation and displayed in the display unit.

Next, the related document search unit 12 searches for the document data related to the input document data (related document data) which is acquired by the input document acquisition unit 11 (step S3 of FIG. 6). Specifically, the related document search unit 12 searches for another document data whose question sentence is the same as or similar to that of the input document data among the document data stored in the document storage unit 20 and extracts it as the related document data. When this process is performed, the related document search unit 12 uses for example, a general similarity degree calculation method such as the Cosine similarity degree described in non-patent document 1. In this case, the related document search unit 12 divides the question sentence into words by using a morphological analysis, sets a weight based on the number of times of appearance of the word by a tf/idf method or the like, and determines that the similarity degree is high if a rate of which the word with a high weight value appears in both question sentences is high. The threshold value of the similarity degree is provided in advance and when the similarity degree between the question sentences is equal to or greater than this threshold value, the related document search unit 12 determines that it is the related document data related to the input document data. In this example, the related document search unit 12 determines the document data 2 and the document data 3 whose sentences of the question part are similar to that of the document data 1 that is the input document data stored by the document storage unit 20 as the related document data and extracts them.

Next, the procedure group search unit 13 searches for the procedure group associated with the input document data or the related document data that is extracted by the related document search unit 12 from the procedure group storage unit 21 and extracts it (step S3 of FIG. 6).

Next, the supplementary information detection unit 14 detects the procedure group (the procedure group including the supplementary information) including a procedure that is the same as or similar to any procedure of the procedure group of the input document data and a procedure that is not the same as or not similar to any procedure of the procedure group of the input document data from the related document data (step S5 of FIG. 6). The method for determining whether the procedures are the same as or similar to each other is obtained by calculating the similarity degree like the way the related document search unit 12 takes. Namely, when the rate of which the word with a high weight value appears in both procedures is equal to or greater than the threshold value, the supplementary information detection unit 14 determines that the procedures are the same as or similar to each other and when the rate is equal to or smaller than the threshold value, it determines that the procedures are not similar to each other. In this example, the procedure P11 included in G11 of the input document data is similar to the procedure P21 of G21 included in the document data 2 and the procedure P11 is not similar to the procedures P22, P23, and P24 of G21. Therefore, the above-mentioned condition is satisfied. The supplementary information detection unit 14 recognizes G21 as the procedure group including the supplementary information to G11 and detects it. Similarly, the supplementary information detection unit 14 recognizes G12 as the procedure group including the supplementary information to G32 and detects it.

Finally, a supplementary information display control unit 15 performs control so that the input document data and the related document data are associated with each other by using the procedure group including the supplementary information and they are displayed in the display unit (step S6 of FIG. 6). For example, as shown in FIG. 2, the supplementary information display control unit 15 writes the anchor text to the portion of G11. When the user (operator) clicks the anchor text, the supplementary information display control unit 15 performs control so that another window in which the sentence that says “there is a procedure that has to be additionally performed in order to solve the problem” and the content of G21 in the document data 2 are highlighted and displayed is displayed.

The user (operator) can read the related document data after the grasping the supplementary information indicating that another procedure required to solve the problem in performing the procedure group of the input document data is described in the procedure group of the related document data. Therefore, the user (operator) can easily grasp the content of the related document data. Further, the supplementary information is grasped before reading the related document data. Therefore, the user (operator) can get the positive motivation for reading the content of the related document data.

Furthermore, the supplementary information display control unit 15 performs control so that the anchor text is written to the portion of G12 and the sentence that is the same as that of G12 and the content of G32 in the document data 3 are highlighted and displayed in a destination page linked by the anchor text. Because such configuration is used, it is enough for the operator to read the portion of G21 of the document data 2 and the portion of G32 of the document data 3 that are associated with each other in the related document data. Therefore, information can be efficiently collected. In fact, the content of G22 of the document data 2 and the content of G31 of the document data 3 are the same as the content of the document data 1. Therefore, it is not necessary to redundantly read those contents.

As mentioned above, in this exemplary embodiment, the procedure group creation unit 10, the supplementary information detection unit 14, and the supplementary information display control unit 15 are included. The procedure group creation unit 10 extracts the portion indicating the procedure from the document data and creates the group of the procedures (the procedure group) to which all procedures that are required to be performed in order to solve a problem belong. The supplementary information detection unit 14 detects the procedure group (the procedure group including the supplementary information) including a procedure that is the same as or similar to any procedure of the procedure group of the input document data and a procedure that is not the same as or not similar to any procedure of the procedure group of the input document data from the related document data. The supplementary information display control unit 15 performs control so that the input document and the related document are associated with each other by using the procedure group including the supplementary information and they are displayed in the display unit.

Accordingly, this exemplary embodiment has the following effect. The related document search system notifies the operator of that the procedure group of the related document data to the procedure group of the input document data (the inquiry log document data that is the object to be read by the operator) is the procedure group including the specific supplementary information. By the notification, the operator can know in advance that another procedure required to solve the problem in performing the procedure group of the input document data is described in the procedure group of the related document data as the supplementary information. Therefore, the operator can easily grasp the content of the related document. Further, the operator grasps the supplementary information in advance and whereby, the operator can get the positive motivation for reading the related document. Because it is enough for the operator to read only the portion of the associated procedure group in the related document data, the operator can efficiently collect information.

### Exemplary Embodiment 2

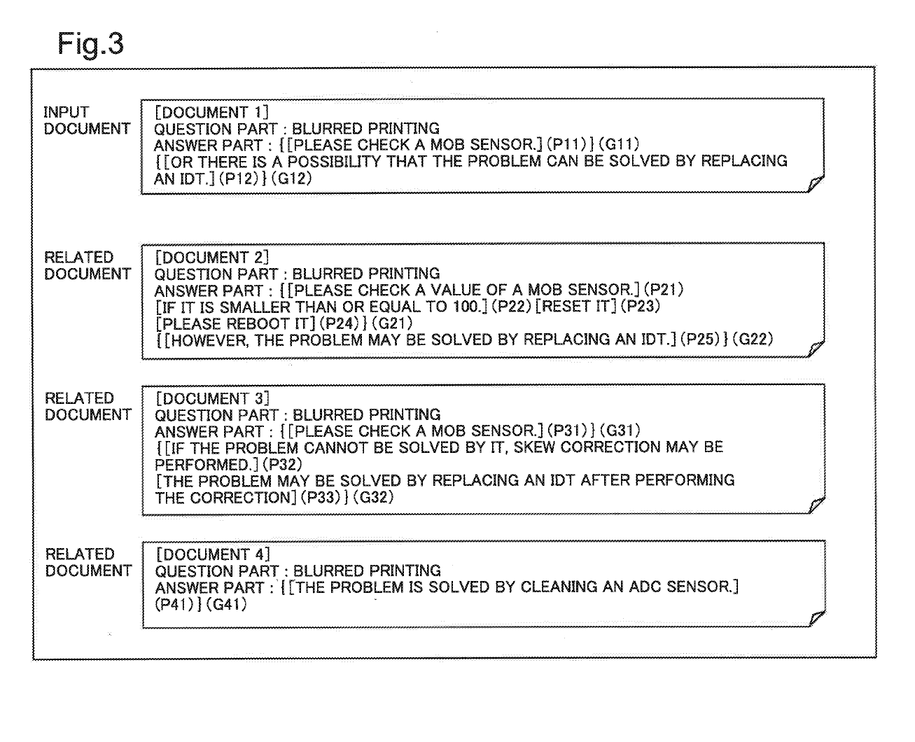

A summary of a second exemplary embodiment of the present invention will be described below. In this exemplary embodiment, a case in which the document data 4 is also the related document data as shown in FIG. 3 in addition to the document data 2 and the document data 3 that are the related document data to the document data 1 used in the explanation of the first exemplary embodiment will be explained as an example. Further, an explanation of a configuration that is the same as that of the first exemplary embodiment will be omitted.

In this exemplary embodiment, another solution detection unit (it corresponds to an other solution detection unit 16 mentioned later) and an other solution display control unit (it corresponds to an other solution display control unit 17 mentioned later) are included in addition to the configuration of the first exemplary embodiment. The other solution detection unit detects the procedure group (the procedure group which uses a different solution) in which all procedures that belong thereto are not the same as or not similar to all procedures that belong to the procedure group included in the input document data among the procedure groups included in the related document data.

The procedure P41 which belongs to G41 of the document data 4 is not similar to the procedures P11 and P12 that are all procedures of the input document data. Therefore, the above-mentioned condition is satisfied. The other solution detection unit recognizes G41 as the procedure group which uses the different solution to the procedure group of the input document data and detects it.

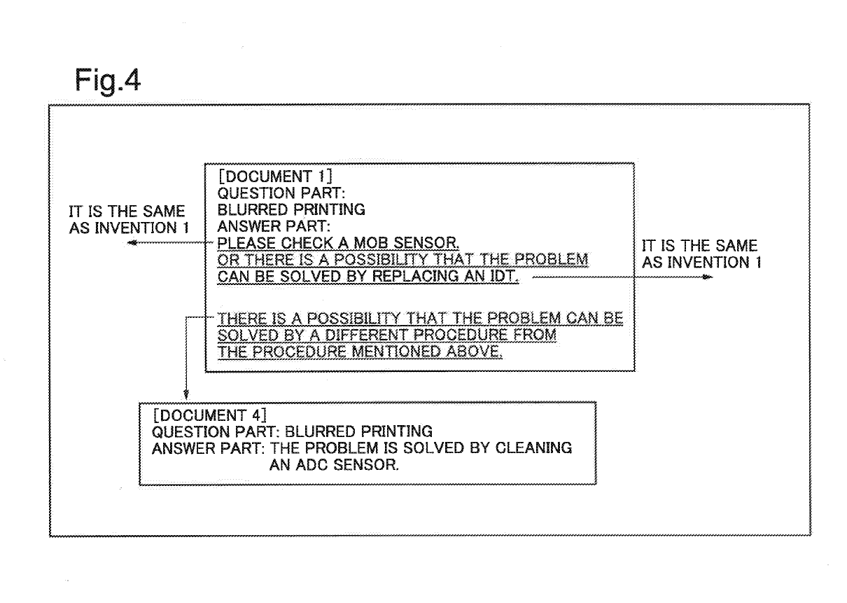

The other solution display control unit performs control so that the input document data and the related document data are associated with each other by using the detected procedure group which uses the different solution and they are displayed. For example, as shown in FIG. 4, the other solution display control unit performs control so that the anchor text that says “there is a possibility that the problem can be solved by a procedure different from the above-mentioned procedure” is written in the lower portion of the input document data and G41 of the document data 4 is highlighted and displayed in the destination page linked by the anchor text. Accordingly, the different procedure for solving the problem that is independent from the execution of the procedure group of the input document data is described in the procedure group of the related document data and whereby, the operator can read the related document data after grasping the existence of the other solution. Therefore, the operator can easily grasp the content of the related document data.

Thus, in the exemplary embodiment, the other solution detection unit and the other solution display control unit are included. The other solution detection unit detects the procedure group (the procedure group which uses a different solution) in which all procedures that belong thereto are not the same as or not similar to all procedures that belong to the procedure group included in the input document data among the procedure groups included in the related document data. The other solution display control unit performs control so that the input document data and the related document data are associated with each other by using the detected procedure group which uses the different solution and they are displayed.

Accordingly, this exemplary embodiment has the following effect. The related document search system in this exemplary embodiment notifies the operator of that the different procedure for solving the problem that is independent from the execution of the procedure group of the input document data is described in the procedure group of the related document data as the other solution. Therefore, the operator can more easily grasp the content of the related document data.

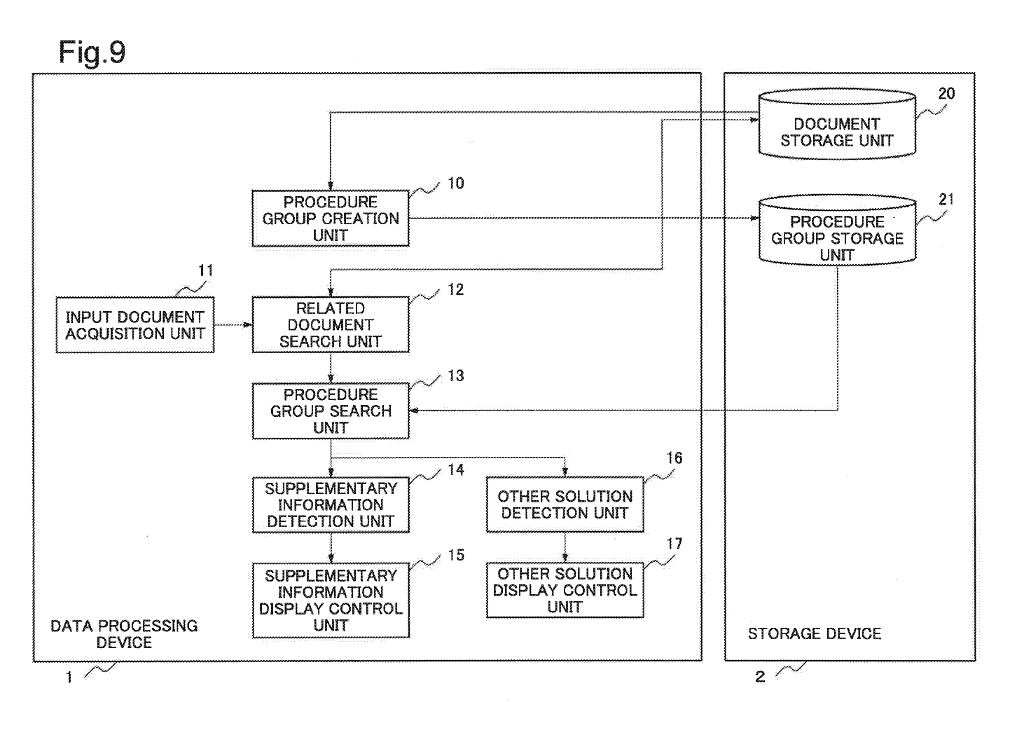

Next, the configuration of the second exemplary embodiment of the present invention will be described with reference to the drawing. FIG. 9 is a functional block diagram showing an example of a functional configuration of the related document search system according to the second exemplary embodiment. By referring to FIG. 9, the related document search system of this exemplary embodiment includes the data processing device 1 which operates by program control and the storage device 2 for storing the information.

The data processing device 1 includes the procedure group creation unit 10, the input document acquisition unit 11, the related document search unit 12, the procedure group search unit 13, the supplementary information detection unit 14, the supplementary information display control unit 15, another solution detection unit 16, and an other solution display control unit 17. The procedure group creation unit 10, the input document acquisition unit 11, the related document search unit 12, the procedure group search unit 13, the supplementary information detection unit 14, and the supplementary information display control unit 15 are the same as those of the first exemplary embodiment. Therefore, the explanation of these units will be omitted.

Specifically, the other solution detection unit 16 is realized by the CPU of the information processing device which operates according to program. The other solution detection unit 16 has a function to detect the procedure group (the procedure group which uses a different solution) in which all procedures that belong thereto are not the same as or not similar to all procedures that belong to the procedure group included in the input document data among the procedure groups included in the related document data.

Specifically, the other solution display control unit 17 is realized by the CPU of the information processing device which operates according to program. The other solution display control unit 17 has a function to perform control so that the input document data and the related document data are associated with each other by using the procedure group which uses the different solution and they are displayed.

The storage device 2 includes the document storage unit 20 and the procedure group storage unit 21. These units are the same as the units of the first exemplary embodiment.

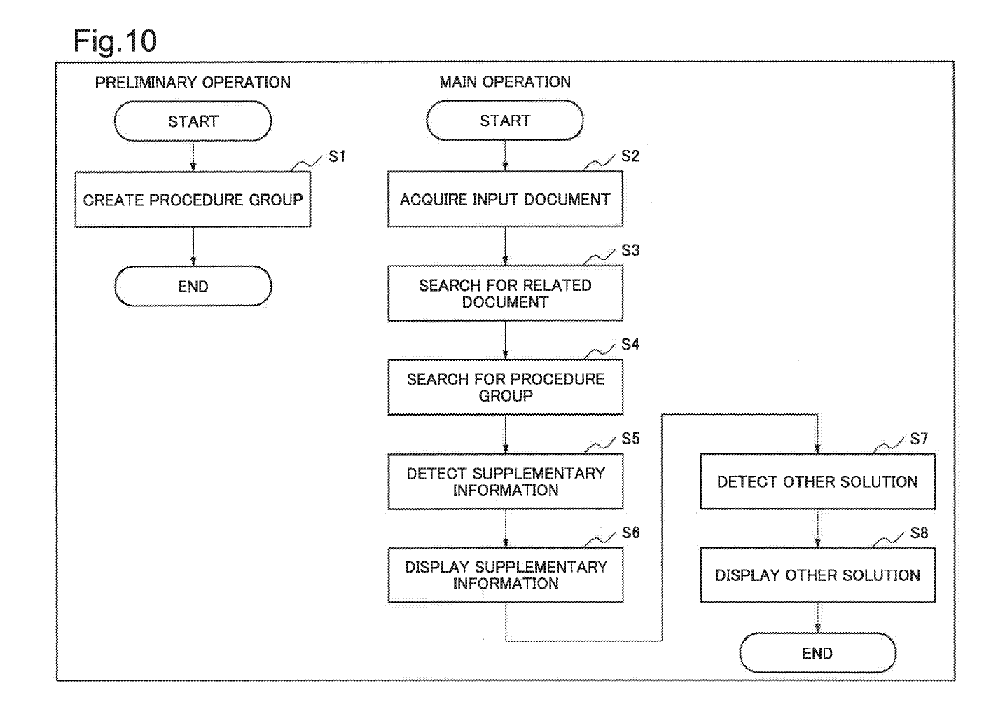

Next, the operation of the related document search system of the exemplary embodiment will be described with reference to FIG. 10. FIG. 10 is a flowchart showing an example of a process performed by the related document search system in the second exemplary embodiment.

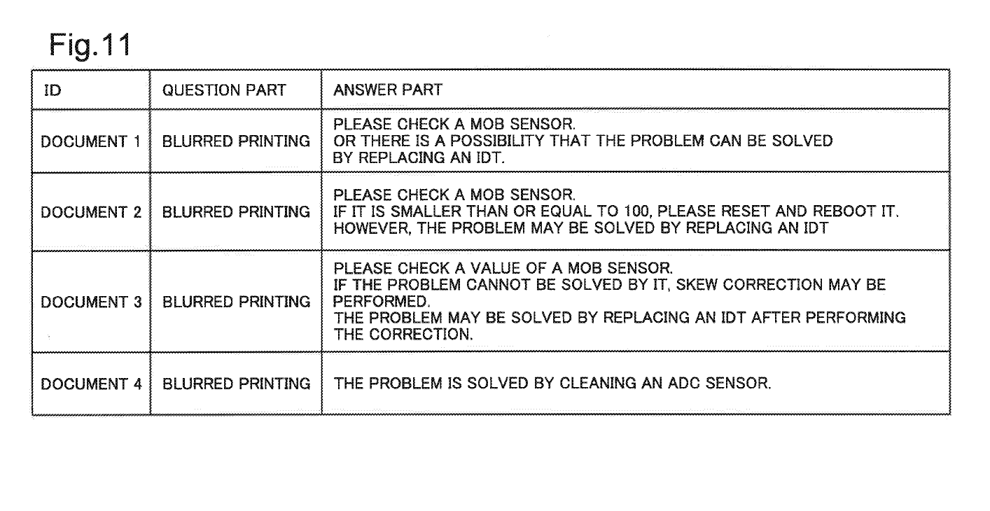

In the this exemplary embodiment, as shown in FIG. 11, the document storage unit 20 stores the document data 1, the document data 2, the document data 3, and the document data 4 as a set of the inquiry log document data. In this exemplary embodiment, a case in which the user (operator) performs the input operation by which the document data 1 is designated as the document that is the object to be read and the input document acquisition unit 11 extracts the document data 1 from the document storage unit 20 according to the user's (operator's) operation will be explained as an example.

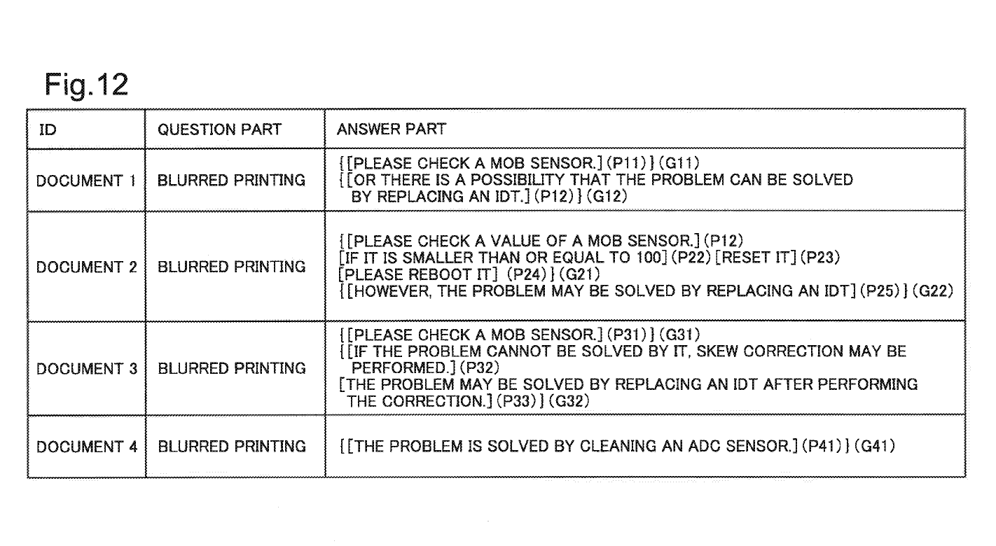

After the related document search system in this exemplary embodiment creates the procedure group included in the document data stored in the document storage unit 20 as the preliminary operation like the first exemplary embodiment, it acquires the supplementary information on the related document data by using the created procedure group as the main operation. In these operations, the preliminary operation is the same as that of the first exemplary embodiment. Therefore, the explanation of this will be omitted. In this exemplary embodiment, it is assumed that the procedure group creation unit 10 creates the procedure group shown in FIG. 12.

Next, the main operation will be described. In the main operation in this exemplary embodiment, the process from START to step 6 in which the supplementary information display control unit 15 performs control so as to display the supplementary information in the display unit in FIG. 10 is the same as the process of the first exemplary embodiment. Therefore, the process after step 6 will be explained.

The other solution detection unit 16 detects the procedure group (the procedure group which uses a different solution) in which all procedures that belong thereto are not the same as or not similar to all procedures that belong to the procedure group included in the input document data among the procedure groups included in the related document data (step S7 shown in FIG. 10). For example, the procedure P41 which belongs to G41 of the document data 4 is not similar to the procedures P11 and P12 that are all procedures of the input document data. Therefore, the above-mentioned condition is satisfied. The other solution detection unit 16 recognizes G41 as the procedure group which uses the different solution to the procedure group of the input document data and detects it.

Finally, the other solution display control unit 17 performs control so that the input document data and the related document data are associated with each other by using the procedure group which uses the different solution and they are displayed in the display unit (step S8 shown in FIG. 10). For example, as shown in FIG. 4, the other solution display control unit 17 performs control so that the anchor text that says “there is a possibility that the problem can be solved by a procedure different from the above-mentioned procedure” is written in the lower portion of the input document data and G41 of the document data 4 is highlighted and displayed in the destination page linked by the anchor text. By this operation, the user (operator) can read the related document data after grasping the existence of the other solution in which the different procedure for solving the problem that is independent from the execution of the procedure group of the input document data is described in the procedure group of the related document data and can easily grasp the content of the related document data.

The other solution detection unit 16 may perform the process without following the order of operations shown in FIG. 10 if the operations are performed after the process performed by the procedure group search unit 13 (step S4) and before the process performed by the other solution display control unit 17 (step S8). Similarly, the other solution display control unit 17 may perform the process without following the order of operations shown in FIG. 10 if the operations are performed after the other solution detection unit 16 performs the process. For example, the related document search system may detect the other solution, display it, and after that, detect and display the supplementary information.

As mentioned above, in this exemplary embodiment, the other solution detection unit 16 and the other solution display control unit 17 are included. The other solution detection unit 16 detects the procedure group (the procedure group which uses a different solution) in which all procedures that belong thereto are not the same as or not similar to all procedures that belong to the procedure group included in the input document data among the procedure groups included in the related document data. The other solution display control unit 17 performs control so that the input document data and the related document data are associated with each other by using the detected procedure group which uses the different solution and they are displayed.

Accordingly, this exemplary embodiment has the following effect. The related document search system in this exemplary embodiment notifies the operator of that the different procedure for solving the problem that is independent from the execution of the procedure group of the input document data is described in the procedure group of the related document data as the other solution. Therefore, the operator can more easily grasp the content of the related document data.

From the above-mentioned explanation, we can say that the present invention has means for solving the problem as shown below. The related document search system in the first exemplary embodiment comprises a procedure group creation unit which extracts the portion indicating the procedure from document data and creates the group of the procedures (the procedure group) to which all procedures that are required to be performed in order to solve a problem belong, a procedure group storage unit which associates the procedure group with the document data and stores them, a related document search unit which searches for the document data related to input document data (related document data), a procedure group search unit which searches for the procedure group which is associated with the input document data and the related document data from the procedure group storage unit, a supplementary information detection unit which detects the procedure group (the procedure group including the supplementary information) of the related document data including both a procedure that is the same as or similar to any procedure of the procedure group of the input document data and a procedure that is not the same as or not similar to all the procedures of the procedure group of the input document data, and a supplementary information display unit which associates the input document data with the related document data by using the procedure group including the supplementary information and displays them.

By adopting such configuration, the related document search system in the first exemplary embodiment can notify the operator of that another procedure required to solve the problem in performing the procedure group of the input document data (the inquiry log document data that is the object to be read by the operator) is described in the procedure group of the related document data as the supplementary information. Therefore, the operator can easily grasp the content of the related document. Further, the operator grasps the supplementary information in advance and whereby, the operator can get the positive motivation for reading the related document. Furthermore, because it is enough for the operator to read only the portion of the associated procedure group in the related document, the operator can efficiently collect the information.

The reason for this is that the related document search system in the first exemplary embodiment comprises the procedure group creation unit which extracts the portion indicating the procedure from the document data and creates the group of the procedures (the procedure group) to which all procedures that are required to be performed in order to solve a problem belong, the supplementary information detection unit which detects the procedure group (the procedure group including the supplementary information) of the related document data including both a procedure that is the same as or similar to any procedure of the procedure group of the input document data and a procedure that is not the same as or not similar to all the procedures of the procedure group of the input document data, and the supplementary information display unit which associates the input document data with the related document data by using the procedure group including the supplementary information and displays them.

The related document search system in the second exemplary embodiment comprises the other solution detection unit which detects the procedure group (the procedure group which uses a different solution) of the related document data that is not the same as or not similar to all procedures to which all procedures of all procedure groups of the input document data belong and an other solution display unit which associates the input document data with the related document data by the procedure group which uses a different solution and displays them in addition to the configuration of the first exemplary embodiment.

By adopting such configuration, the related document search system in the second exemplary embodiment can notify the operator of that the different procedure for solving the problem that is independent from the execution of the procedure group of the input document is described in the procedure group of the related document as the other solution. Therefore, the operator can more easily grasp the content of the related document.

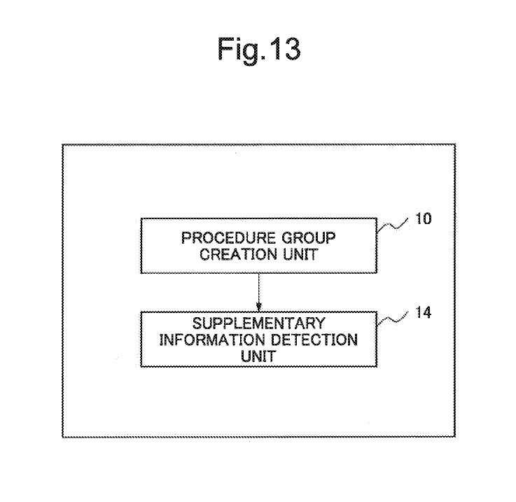

Next, a minimum configuration of the related document search system according to the present invention will be described. FIG. 13 is a block diagram of the related document search device which shows an example of a minimum configuration of the related document search system. As shown in FIG. 13, the related document search device includes the procedure group creation unit 10 and the supplementary information detection unit 14 as a minimum configuration component.

The related document search device with a minimum configuration shown in FIG. 13 performs the preliminary process before searching for the related document data. As the preliminary process, the procedure group creation unit 10 extracts data of the portion corresponding to the procedure that indicates one operation or state from the document data and creates the group of the procedures to which all procedures that are required to be performed in order to solve a problem belong by using the data of the portion corresponding to the extracted procedure as information on the procedure group. When searching for the related document data, the supplementary information detection unit 14 detects the procedure group including the procedure that is the same as or similar to any procedure which belongs to the procedure group including in a predetermined document data and the procedure that is not the same as or not similar to any procedure which belongs to the procedure group from the related document data by using information on the procedure group created by the procedure group creation unit 10 as the procedure group including the supplementary information which supplements the predetermined document data.

Accordingly, by using the related document search device with a minimum configuration, the supplementary information showing the content related to the predetermined document data can be provided together with the related document data related to the predetermined document data.

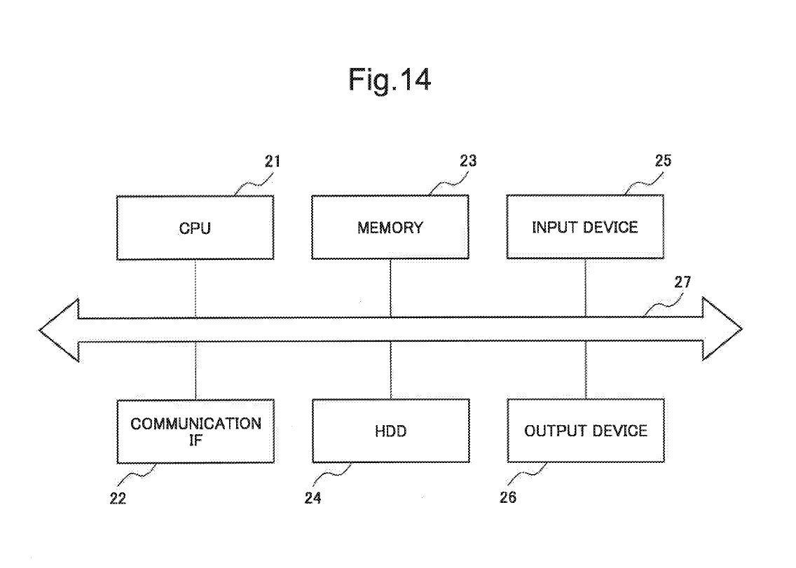

Further, maybe, a program of the present invention is a program which causes a computer to perform each operation explained in the above-mentioned exemplary embodiment. FIG. 14 is a hardware configuration diagram of the related document search device. As shown in FIG. 14, the related document search device is realized by a combination of the CPU (central processing unit) 21, a communication interface (IF) 22, a memory 23, a HDD (hard disk drive) 24, an input device 25, and an output device 26. These components are connected to each other through a bus 27 to input and output the data. The communication IF 22 is an interface for connection with an external network. The input device 25 is for example, a keyboard or a mouse. The output device 26 is for example, a display or the like. An related document search device is realized by executing the program stored in a storage medium such as the memory 23, the HDD 24, or the like by the CPU 21.

In this exemplary embodiment, characteristic configurations of the related document search program are shown in the following items (1) to (5) (however, it is not limited to these items).

(1) The related document search program for searching for the related document data (for example, the document data 2 and the document data 3 that are the related document data) related to the predetermined document data (for example, the document data 1 that is the input document data) characterized by causing a computer to perform: a procedure group creation process (for example, it is realized by the procedure group creation unit 10) in which the procedure (for example, the procedure P11) showing operation or state is extracted from the document data and a group of the procedures to which all procedures that are required to be performed in order to solve a problem belong is created by using the extracted procedure as the procedure group (for example, G11) and a supplementary information detection process in which the procedure group (for example, G21 to G11) including the procedure that is the same as or similar to any procedure which belongs to the procedure group (for example, G11) included in the predetermined document data and the procedure that is not the same as or not similar to any procedure which belongs to the procedure group is detected from the related document data by using the created procedure group as the procedure group including the supplementary information which supplements the content of the predetermined document data.

(2) The related document search program may have a configuration in which a computer is caused to perform the other solution detection process (for example, it is realized by the other solution detection unit 16) in which the procedure group in which all procedures that belong thereto (for example, the procedure P41 that belongs to G41) are not the same as or not similar to all procedures (for example, the procedures P11 and P12 of the document data 1) that belong to the procedure group included in the predetermined document data is detected among the procedure groups included in the related document data as the procedure group which uses a different solution.

(3) The related document search program may have a configuration in which a computer is caused to perform a process for creating the procedure group by using the connection expression (for example, the sentence that says “if the problem cannot be solved by it” or the word of “or”) that exists between two adjacent procedures and shows that the problem can be solved by performing one procedure even when the other procedure is not performed in the procedure group creation process.

(4) The related document search program may have a configuration in which a computer is caused to perform a process for creating the procedure group by using the connection expression (for example, the word of “if” or the sentence that says “if it exists”) that exists between two adjacent procedures and shows that it is necessary to perform both procedures in order to solve the problem in the procedure group creation process.

(5) The related document search program may have a configuration in which a computer is caused to perform a process for creating the procedure group by using the binary classifier in which two adjacent procedures are set as an object to be classified and the categories that say “in order to solve the problem, whether both procedures have to be performed or not?” are set in the procedure group creation process.

As described above, the invention of the present application has been explained with reference to the exemplary embodiment. However, the invention of the present application is not limited to the above-mentioned exemplary embodiment. Various changes in the configuration or details of the invention of the present application that can be understood by those skilled in the art can be made without departing from the scope of the invention.

This application claims priority based on Japanese Patent Application No. 2009-276852, filed on Dec. 4, 2009, the disclosure of which is hereby incorporated by reference in its entirety.

### INDUSTRIAL APPLICABILITY

The present invention can be applied to an application to collect information in a case in which the operator answers the inquiry in a contact center.

### Description of Symbol

1 data processing device

2 storage device

10 procedure group creation unit

11 input document acquisition unit

12 related document search unit

13 procedure group search unit

14 supplementary information detection unit

15 supplementary information display control unit

16 other solution detection unit

17 other solution display control unit

20 document storage unit

21 CPU

22 communication IF

23 memory

24 HDD

25 input device

26 output device

27 bus

1-9. (canceled)

10. A related document search device comprising:
procedure group creation means for extracting data of a portion corresponding to a procedure indicating operation or state from document data and creating a group of the procedures to which all the procedures that are required to be performed in order to solve a problem belong by using the data of the portion corresponding to the extracted procedures as information on a procedure group and
supplementary information detection means for detecting the procedure group including the procedure that is the same as or similar to any procedure which belongs to the procedure group included in a predetermined document data and the procedure that is not the same as or not similar to any procedure which belongs to the procedure group included in the predetermined document data from related document data by using information on the procedure group created by the procedure group creation means as the procedure group including supplementary information which supplements the content of the predetermined document data.

11. A related document search device comprising:
procedure group creation unit that extracts data of a portion corresponding to a procedure indicating operation or state from document data and creating a group of the procedures to which all the procedures that are required to be performed in order to solve a problem belong by using the data of the portion corresponding to the extracted procedures as information on a procedure group and
supplementary information detection unit that detects the procedure group including the procedure that is the same as or similar to any procedure which belongs to the procedure group included in a predetermined document data and the procedure that is not the same as or not similar to any procedure which belongs to the procedure group included in the predetermined document data from related document data by using information on the procedure group created by the procedure group creation unit as the procedure group including supplementary information which supplements the content of the predetermined document data.

12. The related document search device described in claim 11 further comprising other solution detection unit that detects the procedure group in which all procedures that belong thereto are not the same as or not similar to all procedures that belong to the procedure group included in the predetermined document data is detected among the procedure groups included in the related document data as the procedure group which uses a different solution.

13. The related document search device described in claim 11, wherein the procedure group creation unit creates the procedure group by using a connection expression that exists between two adjacent procedures and shows that the problem can be solved by performing one of two procedures even when the other is not performed.

14. The related document search device described in claim 12, wherein the procedure group creation unit creates the procedure group by using a connection expression that exists between two adjacent procedures and shows that the problem can be solved by performing one of two procedures even when the other is not performed.

15. The related document search device described in claim 11, wherein the procedure group creation unit creates the procedure group by using the connection expression that exists between two adjacent procedures and shows that it is necessary to perform both procedures in order to solve the problem.

16. The related document search device described in claim 12, wherein the procedure group creation unit creates the procedure group by using the connection expression that exists between two adjacent procedures and shows that it is necessary to perform both procedures in order to solve the problem.

17. The related document search device described in claim 13, wherein the procedure group creation unit creates the procedure group by using the connection expression that exists between two adjacent procedures and shows that it is necessary to perform both procedures in order to solve the problem.

18. The related document search described in claim 11, wherein the procedure group creation unit creates the procedure group by using a binary classifier in which two adjacent procedures are set as an object to be classified and the categories that ask whether both procedures have to be performed or not in order to solve the problem, are set.

19. The related document search described in claim 12, wherein the procedure group creation unit creates the procedure group by using a binary classifier in which two adjacent procedures are set as an object to be classified and the categories that that ask whether both procedures have to be performed or not in order to solve the problem, are set.

20. The related document search described in claim 13, wherein the procedure group creation unit creates the procedure group by using a binary classifier in which two adjacent procedures are set as an object to be classified and the categories that ask whether both procedures have to be performed or not in order to solve the problem, are set.

21. The related document search described in claim 15, wherein the procedure group creation unit creates the procedure group by using a binary classifier in which two adjacent procedures are set as an object to be classified and the categories that ask whether both procedures have to be performed or not in order to solve the problem, are set.

22. The related document search described in claim 11 further comprising supplementary information display control unit that associates the predetermined document data with the related document data by using the procedure group including supplementary information and displaying them in a display unit.

23. The related document search described in claim 12 further comprising supplementary information display control unit that associates the predetermined document data with the related document data by using the procedure group including supplementary information and displaying them in a display unit.

24. The related document search described in claim 13 further comprising supplementary information display control unit that associates the predetermined document data with the related document data by using the procedure group including supplementary information and displaying them in a display unit.

25. The related document search described in claim 15 further comprising supplementary information display control unit that associates the predetermined document data with the related document data by using the procedure group including supplementary information and displaying them in a display unit.

26. The related document search described in claim 18 further comprising supplementary information display control unit that associates the predetermined document data with the related document data by using the procedure group including supplementary information and displaying them in a display unit.

27. A related document search method comprising:
extracting data of a portion corresponding to a procedure indicating operation or state from document data and creating a group of procedures to which all procedures that are required to be performed in order to solve a problem belong by using the data of the portion corresponding to the extracted procedure as information on a procedure group and
detecting the procedure group including the procedure that is the same as or similar to any procedure which belongs to the procedure group included in a predetermined document data and the procedure that is not the same as or not similar to any procedure which belongs to the procedure group included in the predetermined document data from related document data by using the created information on the procedure group as the procedure group including supplementary information which supplements the content of the predetermined document data.

28. A program recording medium for storing a related document search program which causes a computer to perform:
a procedure group creation process in which data of a portion corresponding to a procedure indicating operation or state is extracted from document data and a group of procedures to which all procedures that are required to be performed in order to solve a problem belong is created by using the data of the portion corresponding to the extracted procedure as information on a procedure group and
a supplementary information detection process in which the procedure group including a procedure that is the same as or similar to any procedure which belongs to the procedure group included in a predetermined document data and a procedure that is not the same as or not similar to any procedure which belongs to the procedure group included in the predetermined document data is detected from related document data by using the created information on the procedure group as the procedure group including supplementary information which supplements the content of the predetermined document data.
